(19) United States
(12) Patent Application Publication
(10) Pub. No.: US 2025/0384574 A1
(43) Pub. Date: Dec. 18, 2025

(54) ASSOCIATING POLYLINES FOR MAP GENERATION

(71) Applicant: QUALCOMM Incorporated, San Diego, CA (US)

(72) Inventors: Mohammadreza MALEK-MOHAMMADI, Solna (SE); Saeed DABBAGHCHIAN, Bromma (SE); Behnaz REZAEI, San Diego, CA (US); Senthil Kumar YOGAMANI, Headford (IE)

(21) Appl. No.: 18/745,915

(22) Filed: Jun. 17, 2024

(51) Int. Cl. G06T 7/70

(52) U.S. Cl. CPC G06T 7/70; G06T 2207/20084; G06T 2207/30252

(57) ABSTRACT

Systems and techniques are described herein for determining object-location information. For instance, a method for determining object-location information is provided. The method may include: generating, using an encoder machine-learning model, a latent-space representation of objects based on a representation of the objects in a scene; clustering points of the latent-space representation of the objects, to generate clusters of points; determining representative values of the clusters of points; and generating, using a decoder machine-learning model, a reconstructed representation of the objects in the scene based on the representative values of the clusters of points.

### TECHNICAL FIELD

The present disclosure generally relates to high-definition (HD)-map generation, refinement, and/or updating. For example, aspects of the present disclosure include systems and techniques for associating and/or denoising points in a latent space to improve HD-map generation, refinement, and/or updating.

### BACKGROUND

High definition (HD) maps may be useful for autonomous, semi-autonomous, and driver assistance systems. For example, HD maps may be used for motion planning because HD maps include information about roads like lane boundaries, road boundaries, pedestrian crossings, and lane dividers. Vectorized-HD-map methods focus on generating polylines and polygons to represent objects such as lane boundaries, road boundaries, pedestrian crossings, and lane dividers.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for determining object-location information. According to at least one example, a method is provided for determining object-location information. The method includes: generating, using an encoder machine-learning model, a latent-space representation of objects based on a representation of the objects in a scene; clustering points of the latent-space representation of the objects, to generate clusters of points; determining representative values of the clusters of points; and generating, using a decoder machine-learning model, a reconstructed representation of the objects in the scene based on the representative values of the clusters of points.

In another example, an apparatus for determining object-location information is provided that includes at least one memory and at least one processor (e.g., configured in circuitry) coupled to the at least one memory. The at least one processor configured to: generate, using an encoder machine-learning model, a latent-space representation of objects based on a representation of the objects in a scene; cluster points of the latent-space representation of the objects, to generate clusters of points; determine representative values of the clusters of points; and generate, using a decoder machine-learning model, a reconstructed representation of the objects in the scene based on the representative values of the clusters of points.

In another example, a non-transitory computer-readable medium is provided that has stored thereon instructions that, when executed by one or more processors, cause the one or more processors to: generate, using an encoder machine-learning model, a latent-space representation of objects based on a representation of the objects in a scene; cluster points of the latent-space representation of the objects, to generate clusters of points; determine representative values of the clusters of points; and generate, using a decoder machine-learning model, a reconstructed representation of the objects in the scene based on the representative values of the clusters of points.

In another example, an apparatus for determining object-location information is provided. The apparatus includes: means for generating, using an encoder machine-learning model, a latent-space representation of objects based on a representation of the objects in a scene; means for clustering points of the latent-space representation of the objects, to generate clusters of points; means for determining representative values of the clusters of points; and means for generating, using a decoder machine-learning model, a reconstructed representation of the objects in the scene based on the representative values of the clusters of points.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system for associating and/or denoising points, according to various aspects of the present disclosure;

FIG. 2 is a block diagram illustrating an example system for associating and/or denoising points, according to various aspects of the present disclosure;

FIG. 3 includes a representation of a top-down view of example polylines and polygons representing objects of a road;

FIG. 4 includes a representation of an example image, as captured by an ego vehicle, overlaid with polylines;

FIG. 5 includes a diagram illustrating an example autoencoder including an encoding network and a decoding network that may be used to associate and/or denoise points, according to various aspects of the present disclosure;

FIG. 6 is a graph illustrating example points in an example latent space, according to various aspects of the present disclosure;

FIG. 7 is a flow diagram illustrating an example process for associating and/or denoising points for HD-map generation, refinement, and/or updating, in accordance with aspects of the present disclosure;

FIG. 8 is a flow diagram illustrating an example process for associating and/or denoising points for HD-map generation, refinement, and/or updating, in accordance with aspects of the present disclosure, in accordance with aspects of the present disclosure;

FIG. 9 is a block diagram illustrating an example of a deep learning neural network that can be used to perform various tasks, according to some aspects of the disclosed technology;

FIG. 10 is a block diagram illustrating an example of a convolutional neural network (CNN), according to various aspects of the present disclosure; and

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

It may be useful for a driving system (e.g., an autonomous, semi-autonomous, or assisted driving systems, which may be referred to herein as an “advanced driver assistance system (ADAS)”) of a vehicle to have map information. Map information may important even for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous, semi-autonomous, or assisted driving systems are an example of where the systems and techniques described may be employed. Also, the systems and techniques described herein may be employed in non-autonomous (e.g., human controlled) vehicles. For example, the systems and techniques may information from map information to a driver of a vehicle.

An ADAS, according to any level of autonomy, may make use of as high-definition (HD) map of the environments of the vehicle of the ADAS. An HD map may include map points-three-dimensional coordinates of surfaces of roads at a sub-meter granularity. An HD map may also include additional features such as lane markers, road signs, traffic lights, traffic signs, poles, etc. ADASs may use HD maps to make determinations about steering, accelerating, braking, path planning, and/or to provide information to a driver, etc.

In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

HD maps may be useful for ADASs, for example, for motion planning since HD maps include information about the roads like lane boundaries, road boundaries, pedestrian crossings, and lane dividers. Vectorized-HD-map methods focus on generating polylines and polygons to represent objects (such as lane boundaries, road boundaries, pedestrian crossings, and lane dividers). For example, pedestrian crossing can be represented as a polygon and lane boundary can be shown with a polyline. Deep-learning-based methods, which may use geometric transformer modules (which may be the same as, or similar to transformers used in large language models and natural language processing) may output polylines and polygons based on camera perspective views and/or lidar point clouds. In the present disclosure, the term “frames” may refer to image frames captured by a camera and/or to a point cloud captured by a point-cloud system, such as a light detection and ranging (LIDAR) system or a radio detection and ranging (RADAR) system. Frames are examples of “captured representations” of a scene, or of objects in a scene.

A vehicle (or a computing system of the vehicle) may capture frames and the vehicle (e.g., online map generation), or another computing device (e.g., offline map generation), may generate an HD map based on the frames. For example, the vehicle may capture frames including representations of objects (such as lane boundaries, road boundaries, pedestrian crossings, and lane dividers). The vehicle, or the other computing device, may determine polylines and/or polygons to represent the objects. The vehicle, or the other computing device, may store the polylines and/or polygons in an HD map.

Additionally or alternatively, a vehicle (or a computing system of the vehicle), or another computing system, may store an HD map and refine and/or update the HD map based on frames. For example, the vehicle may capture frames including representations of objects. The vehicle, or the other computing system, may determine polylines and/or polygons to represent the objects. The vehicle, or the other computing system, may compare the polylines and/or polygons to the objects in the HD map. Where there are differences between the positions of the objects in the HD map and the positions of the objects as represented by the polylines and polygons, the vehicle, or the other computing system, may determine to rely on the polylines and polygons based on the frames. Additionally or alternatively, the vehicle, or the other computing system, may refine and/or update the HD map.

Many objects, (such as lanes boundaries and road boundaries) are continuous, for example, the objects are present in multiple frames. Such objects cannot be adequately localized by simple bounding boxes in a single frame. Moreover many objects (such as lane boundaries and pedestrian crossings) are occluded, have low lighting, and/or are shadowed in some frames but not others.

Systems, apparatuses, methods (also referred to as processes), and computer-readable media (collectively referred to herein as “systems and techniques”) are described herein for associating and/or denoising points for HD-map generation, refinement, and/or updating. For example, the systems and techniques described herein may associate points based on multiple captured representations of an environment and/or denoise the points. The systems and techniques may use the associated and/or denoised points to generate an HD map, to refine an HD map and/or update an HD map. The systems and techniques may implement an efficient way of exploiting previous predictions of polylines and polygons to enhance current prediction in online HD map generation. To do so, the systems and techniques associate current predictions to past predictions and use the associated predictions to perform denoising.

Systems and techniques may exploit prior predictions based on prior representations of objects to improve a current prediction for HD-map generation, refinement, and/or updating. Using prior predictions may improve the way continuous objects (such as lanes boundaries and road boundaries) are represented because using the prior predictions may allow the systems and techniques to associate the continuous objects across many frames. Using prior predictions for occluded, poorly-lit, and/or shadowed, objects may improve the way objects are represented by associating points representing the objects from multiple frames, in some of which the objects may not be occluded, poorly-lit, and/or shadowed.

Some objects in HD maps (like lanes boundaries, road boundaries, dividers, and pedestrian crossings) are static which makes tracking the objects and associating the objects between multiple frames simpler and/or more effective. The systems and techniques take advantage of the fact that some objects are stationary to cluster and track different detections of the objects across multiple frames. To associate the objects between frames, the systems and techniques may represent the objects in a reference coordinate system rather than in the frame of reference of any one of the frames.

The systems and techniques may use centroids of clusters to track and denoise the predictions since while representing the same object, a centroid comes as the arithmetic mean of points belonging to the same cluster in the latent space. This in turn reduces some of the random fluctuations of points in the same cluster and hence enables tracking and improves the performance.

In a vectorized HD map, each object is represented with a set of points or vertices. As points from the same object in multiple consecutive frames represent extensions of the same object, these points should have the same representation in some latent space. The systems and techniques may use a trained autoencoder (AE) to find a suitable latent representation of predicted polylines and polygons so the polylines and polygons can be accurately clustered and tracked them in suitable latent space.

As a brief summary of some of the operations, the systems and techniques may obtain multiple frames, determine a latent-space representation for each of the multiple frames, and cluster points from each of the latent-space representations. The systems and techniques may store the latent-space representations and the cluster associations.

Then, the systems and techniques may then obtain a new frame. The systems and techniques may generate predictions (e.g., polylines and/or polygons) based on the new frame. The systems and techniques may transform the predictions into a world coordinate system. In the world coordinate system, the origin may be fixed, for example, to the start of ego-trajectory.

The systems and techniques may project the predicted and transformed objects (polylines and polygons) based on the new frame into the latent space using the encoder part of the trained AE. Then, the systems and techniques may classify the latent-space predictions of the new frame using a clustering algorithm (for example, DBSCAN or mean shift) to determine to which cluster the predictions belong. For each cluster that gets a new point (prediction), the systems and techniques may calculate the mean of cluster (e.g., a centroid).

Next, the systems and techniques may pass the new centroids through the decoder part of the AE to calculate new polygons/polylines in the world coordinate. In some aspects, the systems and techniques may transform the updated predictions back to the local coordinate system and adjust their representation in the perspective or range views.

As another brief summary of some of the operations, the systems and techniques may use AEs to transform predicted polylines and polygons (e.g., one encoder of one AE for polylines and another encoder of another AE for polygons) to a latent space. The systems and techniques may organize predictions of the same polyline or polygon in consecutive frames to a same cluster in the latent space. Each cluster may be represented by its centroid which may be the arithmetic mean of the points belonging to the cluster. This allows tracking and denoising a current prediction as taking the mean decreases random/noisy components from the prediction. The systems and techniques then transform the centroids from the latent space into a set of points in a world coordinate system using the decoder parts of AEs to have 3D points of the denoised polygons or polylines.

The dimensionality of the latent space is a hyper-parameter which may be tuned during training of the AEs and/or of the systems and techniques as a whole. The lower dimensionality of the latent space (as compared to the input space, for example, of polylines and/or polygons) leads to a faster clustering of predictions and processing the previous predictions as a set of points. Because the encoders and decoders are frozen during inference, the systems and techniques have lower complexity than approaches that may operate on images or point clouds. Further, the systems and techniques can be added to any existing model. Though the systems and techniques may have relatively low complexity and high flexibility, the systems and techniques can improve the accuracy of HD map generation.

The systems and techniques may use an autoencoder architecture in which the encoder transfers the raw points of a polygon or polyline into latent space representation. Then the systems and techniques may cluster predictions in consecutive frames and pick the centroid of each cluster. Centroids in latent space pass through the decoder to “denoise” the noisy predictions and hence improve the prediction accuracy. One advantage of this approach is that this approach is computationally cheap as compared with using images from previous frames. This approach works directly with polygon and polyline predictions which are fundamentally a set of points or vertices which have a lower dimensionality than images. Additionally, because the temporal-fusion method is model agnostic, the temporal-fusion method can be added on top of any existing method to improve the prediction.

There are many advantages of the systems and techniques over other techniques. For example, the systems and techniques may improve the accuracy of polylines and/or polygons by incorporating past predictions. By transferring past and current predictions to a latent space and clustering them, the systems and techniques denoise current prediction and improve the performance of the model.

Further, the systems and techniques may enable model-agnostic tracking and denoising. The systems and techniques can be applied with relatively few modifications on top of any vectorized HD map model to enhance the performance and more efficiently utilize predictions history.

Additionally, the systems and techniques may be relatively light-weight in terms of computational budget. Since clustering is done in lower dimensional, latent space and is applied on vectorized inputs (i.e., not on rasterized or segmentation maps or raw images), clustering is fast and not as complex as clustering raw images or maps. This means that the systems and techniques can be easily integrated into existing models.

Training the systems and techniques is unsupervised and doesn't need extra annotations. To train the encoders and decoders, the systems and techniques use AE architecture which is an unsupervised model and doesn't need any extra annotations.

The systems and techniques enable more sophisticated algorithms. The denoising of the systems and techniques opens the door for using more advanced machine-learning models for lanes and road boundary detection given more compute resources.

The systems and techniques may be data efficient—for example, the systems and techniques may use less training data than other techniques. Because the systems and techniques use unsupervised models, and yet enhances the accuracy of the predictions, the systems and techniques reduce the amount of training data for a given level of accuracy in the predictions.

The systems and techniques may be used to generate HD maps, refine HD maps, update HD maps, and/or determine how to use HD maps as compared to captured representations.

Various aspects of the application will be described with respect to the figures below.

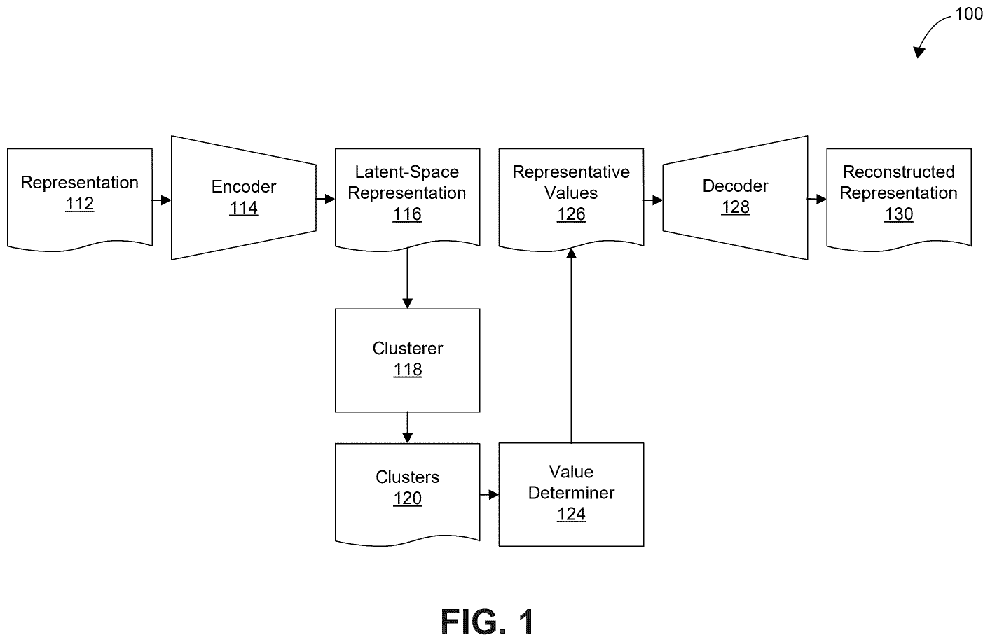

FIG. 1 is a block diagram illustrating an example system 100 for associating and/or denoising points, according to various aspects of the present disclosure. In general, system 100 may obtain a representation 112, encode representation 112 at an encoder 114 to generate a latent-space representation 116, cluster points of latent-space representation 116 at a clusterer 118 to generate clusters 120, determine representative values 126 of clusters 120 at a value determiner 124, and decode representative values 126 at a decoder 128 to generate reconstructed representation 130.

Representation 112 may be, or may include, a representation of objects in a scene. In some aspects, representation 112 may be, or may include, a line-based representation of objects (such as polylines and/or polygons). Representation 112 may be based on a frame (e.g., an image frame, a LIDAR capture, or a RADAR capture). The objects may be, or may include, for example, boundaries of at least one lane on a road, at least one edge of the at least one lane of the road, dividers of the at least one lane of the road, markings of the at least one lane of the road, on-road traffic markings of the road, and/or crosswalk markings of the road.

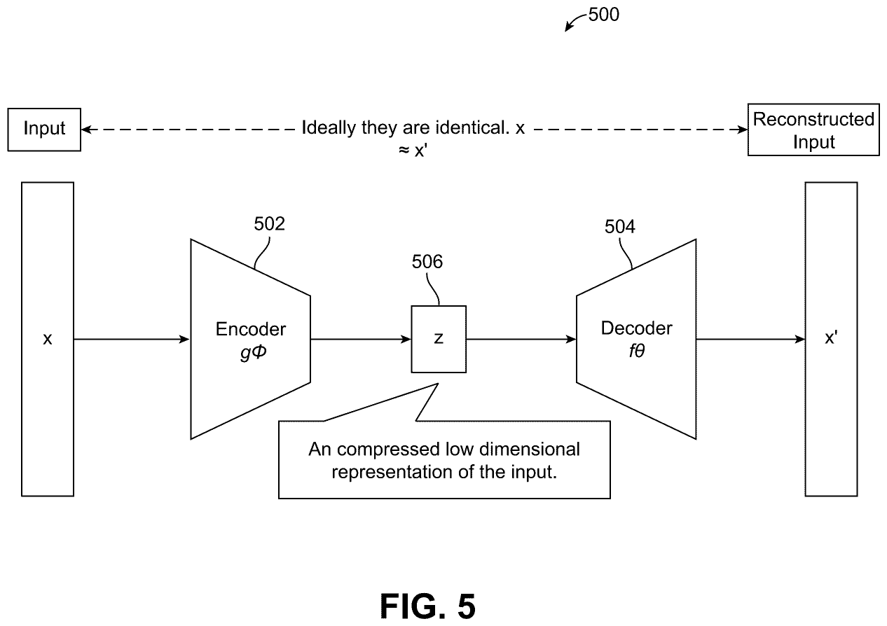

Encoder 114 may be, or may include, a machine-learning model encoder. Encoder 114 may be trained with decoder 128 as an autoencoder network. For example, encoder 114 and decoder 128 may be trained together to encode data from an input-dimension space, to a latent space, then to decode the data from the latent space to an output-dimension space (which may have the same dimensionality as the input-dimension space). Encoder 114 and decoder 128 may be trained together to reproduce the data accurately. Additional description regarding the training of encoder 114 and decoder 128 is provided with regard to FIG. 5.

Encoder 114 and decoder 128 may be, or may include, multiple encoder networks and multiple decoder networks. For example, encoder 114 may include one encoder network for polylines and another encoder network for polygons. Likewise, decoder 128 may include one decoder network for polylines and another decoder network for polygons.

Latent-space representation 116 may be, or may include, a latent-space representation of representation 112. For example, encoder 114 may encode representation 112 from dimensions of representation 112 to a lower dimensionality.

Clusterer 118 may cluster latent-space representation 116 into clusters 120. For example, clusterer 118 may cluster points of latent-space representation 116 that are similar in the latent space. Clustering latent-space representation 116 may be, or may include, associating points of latent-space representation 116 with others of latent-space representation 116. In some aspects, clusterer 118 may cluster points of latent-space representation 116 with points from previously-determined instances of latent-space representation 116 and/or previously-determined instances of clusters 120. Clusterer 118 may implement, as examples, Density-Based Spatial Clustering of Applications with Noise (DBSCAN), random sample consensus (RANSAC), or mean shift.

Value determiner 124 may generate one of representative values 126 for each of clusters 120. In some aspects, each of representative values 126 may be a centroid of a respective one of clusters 120.

Decoder 128 may decode representative values 126 to generate reconstructed representation 130. Reconstructed representation 130 may be similar to representation 112. For example, reconstructed representation 130 may represent the same objects as representation 112. Further, reconstructed representation 130 may include the same dimensions as representation 112.

However, reconstructed representation 130 may be more accurate than (e.g., exhibit less noise than) representation 112. For example, by clustering latent-space representation 116 to generate clusters 120 and determining representative values 126 based on clusters 120, system 100 may cause related points of representative values 126 to be more similar to one another (in the latent space) than the related points of latent-space representation 116 are to one another. Because the related points of representative values 126 are more similar to one another than the related points of latent-space representation 116, reconstructed representation 130 may exhibit less noise than representation 112. Additionally, because reconstructed representation 130 may be based on historical instances of latent-space representation 116 (e.g., which may be based on prior frames), reconstructed representation 130 may be more smooth and less affected by bad frames, or frames in which an object is occluded, poorly lit, or shadowed.

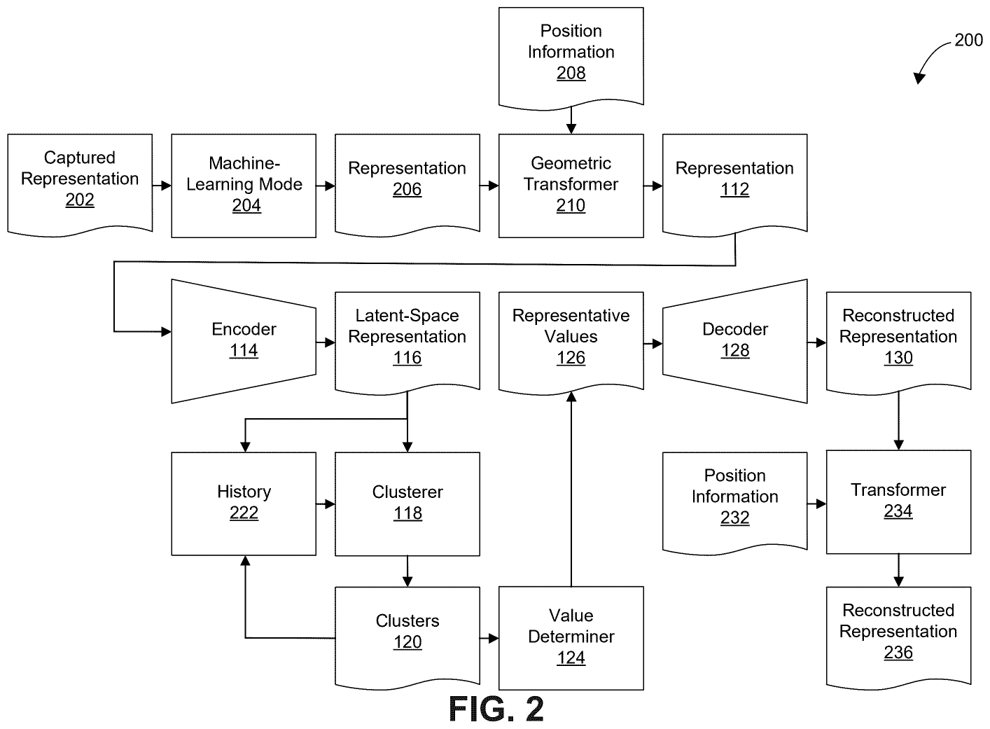

FIG. 2 is a block diagram illustrating an example system 200 for associating and/or denoising points, according to various aspects of the present disclosure. System 200 includes representation 112, encoder 114, latent-space representation 116, clusterer 118, clusters 120, value determiner 124, representative values 126, decoder 128, and reconstructed representation 130 of system 100 of FIG. 1. System 200 includes additional elements that are optional and/or provide context for using system 100 in an ADAS.

System 200 may obtain a captured representation 202. Captured representation 202 may be, for example, a frame, such as an image frame, a LIDAR point cloud, or a RADAR point cloud. Captured representation 202 may be captured by a camera, LIDAR system, or RADAR system of a vehicle, for example, as the vehicle travels on a road. Captured representation 202 may include representations of objects, such as, lanes boundaries, road boundaries, dividers, and pedestrian crossings.

Machine-learning model 204 may generate representation 206 based on captured representation 202. Representation 206 may be, or may include, a line-based representation of objects represented by captured representation 202. Representation 206 may be, or may include, polylines and/or polygons. Machine-learning model 204 may be trained to generate line-based representations based on images and/or point clouds.

Transformer 210 may transform representation 206 to generate representation 112. Representation 206 may be relative to a coordinate system of the vehicle that captured captured representation 202. The vehicle that captured captured representation 202 may be referred to as an “ego vehicle.” A coordinate system of the ego vehicle may be referred to as an “ego coordinate system.” An ego coordinate system may have a point of the ego vehicle as an origin. Because the ego vehicle may move, if multiple captured representation 202 are generated while the ego vehicle moves, it may be important to transform the multiple instances of representation 206 (which may be relative to the ego coordinate system) to be relative to a reference coordinate system so that the multiple instances of representation 112 can be related one to another. A reference coordinate system may have a constant origin. Transformer 210 may apply a matrix to transform representation 206 to representation 112. The matrix may be based on the origin of the reference coordinate system and position information 208 (which may indicate a current position of the ego vehicle).

As described with regard to system 100 of FIG. 1, encoder 114 may encode representation 112 to generate latent-space representation 116. Further, clusterer 118 may cluster latent-space representation 116 into clusters 120.

History 222 may store historical instances of latent-space representation 116 and/or clusters 120. For example, history 222 may store a number (e.g., 50) of the most recent instances of latent-space representation 116 and/or clusters 120. Clusterer 118 may cluster points of latent-space representation 116 not only with other points of latent-space representation 116 but with points of historical instances of latent-space representation 116 and/or historical instances of clusters 120.

As described with regard to system 100 of FIG. 1, value determiner 124 may determine one of representative values 126 for each of clusters 120. Further, representative values 126 may decode value determiner 124 to generate reconstructed representation 130.

In some aspects, a transformer 234 may transform reconstructed representation 130 to generate reconstructed representation 236. For example, transformer 234 may transform reconstructed representation 130 from a reference coordinate system, into an ego coordinate system to allow the ADAS to more directly use reconstructed representation 130. In some aspects, transformer 234 may be the inverse of transformer 210. Transformer 234 may transform reconstructed representation 130 based on position information 232, which may be the same as position information 208.

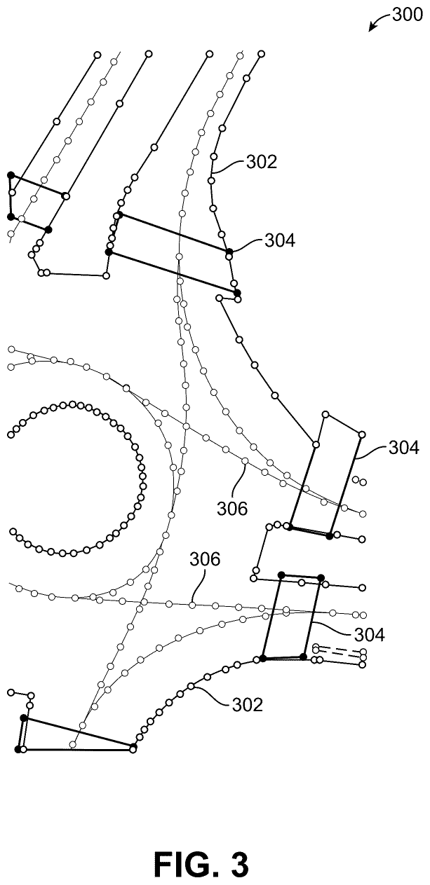

FIG. 3 includes a representation 300 of a top-down view of example polylines and polygons representing objects of a road. For example, representation 300 includes polylines 302 which may represent lane boundaries, polygons 304 that may represent pedestrian crossings, and polylines 306 that may represent lane centerlines. Each of polylines 302, polygons 304, and polylines 306 may be made up of a number of points and/or of lines between the points. Data representing locations of points of polylines 302, polygons 304, and/or polylines 306 may be determined according to various aspects of the present disclosure and may be used to generate, update, and/or refine HD maps.

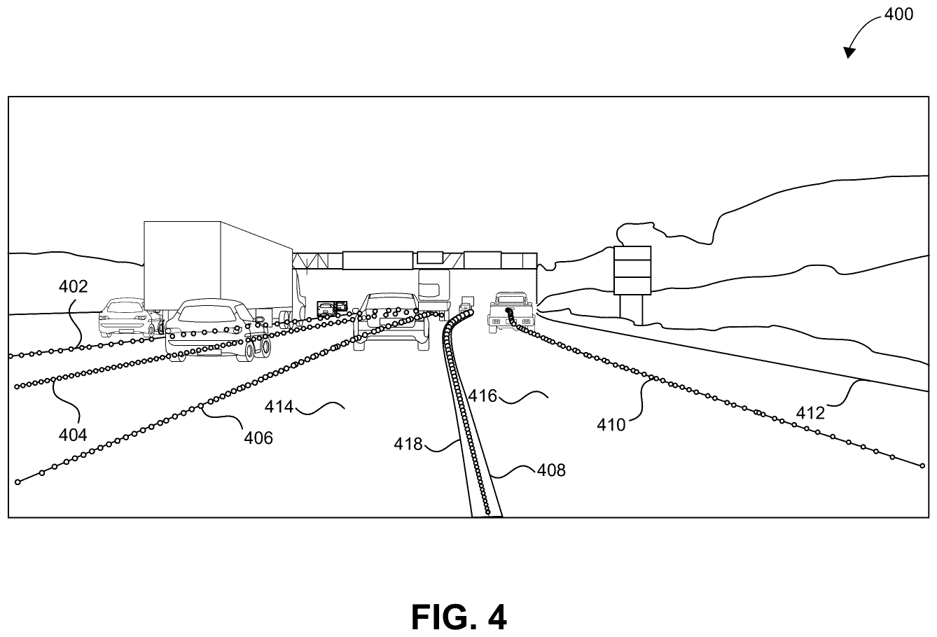

FIG. 4 includes a representation 400 of an example image, as captured by an ego vehicle, overlaid with polylines. Representation 400 includes objects, such as, lane boundary 402, lane boundary 404, lane boundary 406, lane boundary 408, lane boundary 410, road boundary 412, centerline 414, and centerline 416. The objects in representation 400 abstracted from visibly distinct markers. For example, lane boundary 406 may be extrapolated based on a dashed line marking lane boundary 406. As an example, though not visibly marked, lanes may include centerlines (defined between lane boundaries).

Representation 400 is overlaid with polylines points making up polylines. The polylines may be determined based on one or more representations, such as and including representation 400. For example, polyline 418 may be determined based on representation 400 and other representations captured by the same camera at about the same time.

FIG. 5 includes a diagram illustrating an example autoencoder 500 including an encoding network 502 and a decoding network 504 that may be used to associate and/or denoise points, according to various aspects of the present disclosure. In some aspects, encoding network 502 and decoding network 504 may be trained together as autoencoder 500. Further, encoding network 502 and decoding network 504 may be used to associate and/or denoise points, according to various aspects of the present disclosure. For example, encoder 114 of FIG. 1 and FIG. 2 may be trained according to the description of training encoding network 502 of autoencoder 500 and decoder 128 of FIG. 1 and FIG. 2 may be trained according to the description of training of decoding network 504 of autoencoder 500.

Encoding network 502 and decoding network 504 may be trained together (e.g., as autoencoder 500) according to an end-to-end training process. Autoencoder 500 may be trained to a decrease a dimensionality of an input to generate a latent-space representation, then increase the dimensionality of the latent-space representation (e.g., back to the original dimensionality) to generate an output. Autoencoder 500 may be trained to minimize a difference between the input and the output.

Encoder 114 may include two encoders, for example, one encoder for polylines and one encoder for polygons. Similarly, decoder 128 may include two decoders, for example, one decoder for polylines and one decoder for polygons. One instance of encoding network 502 may be trained to encode polylines and another instance of encoding network 502 may be trained to encode polygons. Similarly, one instance of decoding network 504 may be trained to decode polylines and another instance of decoding network 504 may be trained to decode polygons.

For example, an input may be represented as:

$${\{ {p}_{i , j} \}}_{i = 1}^{N}$$

where p represents points of the input;
where i represents the ith point of a polyline or polygon;
where j represents the jth polyline or polygon; and
where N represents a total number of points of a polyline or polygon.

An output may be represented as

$${\{ \}}_{i = 1}^{N}$$

where \hat{p} represents points of the output;
where i represents the ith point of a polyline or polygon;
where j represents the jth polyline or polygon; and
where N represents a total number of points of a polyline or polygon.

Autoencoder 500 may be trained to minimize a difference between input data and an output of autoencoder 500. The input data may be used as a ground-truth when compared with the output of autoencoder 500. For example, autoencoder 500 may be trained based on an 12 norm loss between the output and the input. For example, the loss for a given polyline or polygon may be determined according to:

$${L}_{j} = {\sum }_{i = 1}^{N} {‖ {p}_{i , j} - ‖}^{2}$$

where Lⱼ represents the loss for a given polyline or polygon j;
where i represents the ith point of a polyline or polygon;
where j represents the jth polyline or polygon; and
where N represents a total number of points of a polyline or polygon.

A loss for autoencoder 500 for a number of polylines or polygons may be determined according to:

$$L = \frac{1}{M} {\sum }_{j = 1}^{M} {L}_{j}$$

where L represents the loss;
where j represents the jth polyline or polygon; and
where M represents a total number of polylines or polygons.

Further, the total loss for autoencoder 500 may be determined according to:

$$L = \frac{1}{N M} {\sum }_{j = 1}^{M} {\sum }_{i = 1}^{N} {‖ {p}_{i , j} - ‖}^{2}$$

where L represents the loss;
where p represents points of the input;
where \hat{p} represents points of the output;
where i represents the ith point of a polyline or polygon;
where j represents the jth polyline or polygon;
where N represents a total number of points of a polyline or polygon; and
where M represents a total number of polylines or polygons.

Encoding network 502 and decoding network 504 may include any number of layers and any number of nodes per layer. The number of layers and the number of nodes per layer may be hyperparameters that may be adjusted to improve performance of system 100 or system 200.

Using encoding network 502 as an example of encoder 114 and decoding network 504 as an example of decoder 128, latent-space representation 116 may be values taken from nodes at center 506 of autoencoder 500. Center 506 may be an end of encoding network 502 and a beginning of decoding network 504. Further, representative values 126 may be provided to nodes at center 506.

In some aspects, autoencoder 500 may be trained using training data that is also used to train an HD map generator. For example, there may be a set of training data that is used to train an online HD map generator. Autoencoder 500 may be trained using that data. Thus, autoencoder 500 may be trained without obtaining new or unique training data.

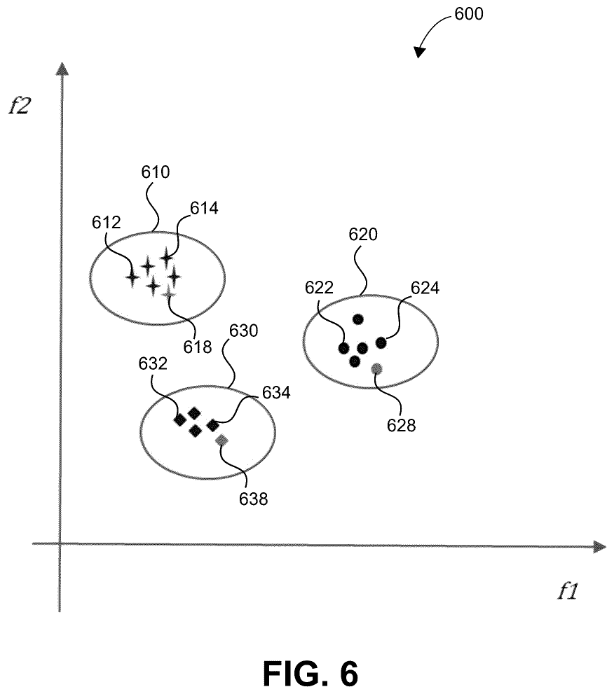

FIG. 6 is a graph 600 illustrating example points in an example latent space. The points of graph 600 include points clustered into three clusters, according to various aspects of the present disclosure. For example, graph 600 includes point 612, point 614, and point 618 clustered into cluster 610, point 622, point 624, and point 628 clustered into cluster 620, and point 632, point 634, and point 638 clustered into cluster 630. Clustering may involve grouping the points into clusters or identifying the clusters of groups. Clustering may be performed separately for polylines and polygons.

The points of graph 600 may be examples of points of latent-space representation 116 of FIG. 1 and FIG. 2. The clusters of graph 600 may be examples of clusters defined by clusterer 118 of FIG. 1 and FIG. 2. For simplicity, graph 600 is a two-dimensional graph. Latent-space representation 116 may include any number of dimensions. Clusterer 118 may cluster latent-space representation 116 according to the number of dimensions of latent-space representation 116.

The points of graph 600 may represent points of a latent-space representation of a single frame. For example, all the points of graph 600 may represent points of a single instance of latent-space representation 116. In such a case, all the points of a single cluster may relate to a single polyline or polygon (which may be based on a single object).

Alternatively, the points of graph 600 may represent points of a latent-space representation of multiple frames. For example, the points of graph 600 may represent points of latent-space representation 116 and historical instances of latent-space representation 116 from history 222. Additionally or alternatively, the clusters of graph 600 may be based on historical instances of clusters 120 from history 222. For example, point 612, point 622, and point 632 may be from a first historical instance of latent-space representation 116 from history 222. Point 614, point 624, and point 634 may be from a second historical instance of latent-space representation 116 from history 222. Point 618, point 628, and point 638 may be from a current (or most recent) instance of latent-space representation 116.

Value determiner 124 may determine one of representative values 126 for each of clusters 120. Using the points and clusters of graph 600 as an example, value determiner 124 may determine a representative value of cluster 610, a representative value of cluster 620, and a representative value of cluster 630. The representative values may be centroids. The representative values may be an P-dimensional arithmetic mean of the Q points of a cluster, where P is the dimensionality of the points in the latent space and Q is the number of points in the cluster. Using the points of graph 600 as an example, a representative value of cluster 610 may be the two-dimensional arithmetic mean of the 6 points of cluster 610.

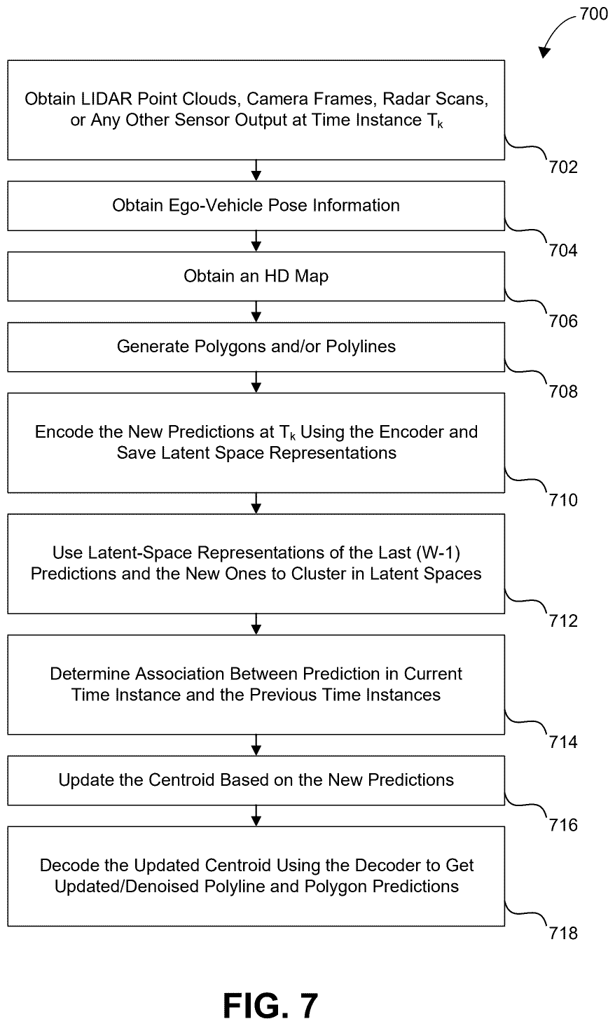

FIG. 7 is a flow diagram illustrating an example process 700 for associating and/or denoising points for HD-map generation, refinement, and/or updating, in accordance with aspects of the present disclosure. One or more operations of process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 700. The one or more operations of process 700 may be implemented as software components that are executed and run on one or more processors.

At block 702, a computing device (and/or one or more component thereof) may obtain LIDAR point clouds, camera frames, radar scans, or any other sensor output at time instance Tk. For example, system 200 may obtain captured representation 202.

At block 704, the computing device (and/or one or more component thereof) may obtain ego-vehicle pose information. For example, system 200 may obtain position information 208.

At block 706, the computing device (and/or one or more component thereof) may obtain an HD map. For example, at block 706, the computing device (and/or one or more component thereof) may generate an HD map. A machine-learning model may be trained to predicts lane and road boundaries as polylines and pedestrian crossings as polygons, for example, for HD map generation. The input to the machine-learning model may be sensor data like camera images and/or LIDAR point clouds. The machine-learning model may include several deep-learning components such as convolutional neural networks and transformer modules. At block 706, the computing device (or one or more components thereof) may obtain an output of such a model based on several frames of input image data and/or LIDAR point clouds.

At block 708, the computing device (and/or one or more component thereof) may generate polygons and/or polylines. For example, machine-learning model 204 of system 200 may generate representation 206 based on captured representation 202. Representation 206 may be, or may include, polyline and polygon representations of objects represented by captured representation 202.

At block 710, the computing device (and/or one or more component thereof) may encode the new predictions at Tk using the encoder and save latent space representations. For example, encoder 114 may encode representation 112 as latent-space representation 116. System 200 may store latent-space representation 116 at history 222.

At block 712, the computing device (and/or one or more component thereof) may use latent-space representations of the last (W-1) predictions and the new ones to cluster in latent spaces.

For example, the computing device (and/or one or more component thereof) may select a look-back sliding window size, W, in which the computing device (and/or one or more component thereof) may keep a history of previous predictions. For example, clusterer 118 may cluster points of latent-space representation 116 with points of prior instances of latent-space representation 116 stored in history 222. The computing device (and/or one or more component thereof) may to store the polylines, the polygons (e.g., latent-space representation 116), and the ego-position (e.g., position information 208). From past predictions within the sliding window, history 222 may store latent representation for clustering and association. There is no need for the computing device (and/or one or more component thereof) to store the sensor outputs (e.g., captured representation 202). Not storing captured representation 202 may reduce memory requirements.

At block 714, the computing device (and/or one or more component thereof) may determine association between prediction in current time instance and the previous time instances (e.g., by clustering). For example, clusterer 118 may associate points of clusters 120, the points of clusters 120 are points of latent-space representation 116 and prior instances of latent-space representation 116 stored by history 222. The clustering may be done separately for polylines and polygons. Clusters 120 may include separate autoencoders trained on polylines and polygons respectively.

At block 716, the computing device (and/or one or more component thereof) may update the centroid based on the new predictions. For example, value determiner 124 may determine values (e.g., centroids) of the clusters 120 that were updated with new points of latent-space representation 116 of the new predictions Tk.

At block 718, the computing device (and/or one or more component thereof) may decode the updated centroid using the decoder to get updated/denoised polyline and polygon predictions. For example, decoder 128 may decode representative values 126 to generate reconstructed representation 130.

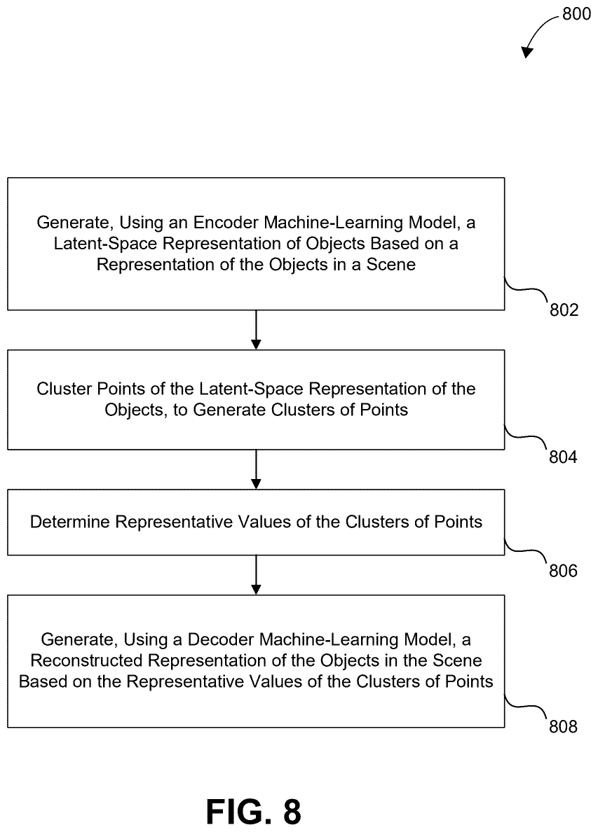

FIG. 8 is a flow diagram illustrating an example process 800 for associating and/or denoising points for HD-map generation, refinement, and/or updating, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 800. The one or more operations of process 800 may be implemented as software components that are executed and run on one or more processors.

At block 802, a computing device (or one or more components thereof) may generate, using an encoder machine-learning model, a latent-space representation of objects based on a representation of the objects in a scene. For example, encoder 114 of FIG. 1 may generate latent-space representation 116 based on representation 112.

In some aspects, the computing device (or one or more components thereof) may obtain a captured representation of the scene; and generate, using a machine-learning model, the representation of the objects of the scene based on the captured representation of the scene. For example, machine-learning model 204 of FIG. 2 may obtain captured representation 202 and generate representation 206 based on captured representation 202. In some aspects, transformer 210 may transform representation 206 (e.g., based at least in part on position information 208) to generate Representation 112. Representation 112 may be an example of the representation used at block 802.

In some aspects, the captured representation of the scene may be, or may include, at least one of an image of the scene or a point-cloud representation of the scene. For example, captured representation 202 may be, or may include, an image of the scene and/or a point-cloud representation of the scene.

In some aspects, the point-cloud representation of the scene may be based on at least one of a light detection and ranging (LIDAR) capture of the scene or a radio detection and ranging (RADAR) capture of the scene. For example, captured representation 202 may be, or may include, a LIDAR and/or RADAR capture of the scene.

In some aspects, the representation of the objects comprises at least one of a polyline representation of the objects or a polygon representation of the objects. For example, representation 112 may be, or may include, a polyline representation of the objects and/or a polygon representation of the objects.

At block 804, the computing device (or one or more components thereof) may cluster points of the latent-space representation of the objects, to generate clusters of points. For example, clusterer 118 of FIG. 1 may cluster points of latent-space representation 116 to generate clusters 120.

In some aspects, to cluster the points of the latent-space representation of the objects, the computing device (or one or more components thereof) may update previously-determined clusters of points of latent-space representations of the objects, based on the points of the latent-space representation of the objects, to generate the clusters of points. For example, clusterer 118 may store clusters of points in history 222 and update previously-determined clusters of points based on determined clusters of points based on latent-space representation 116.

In some aspects, the previously-determined clusters of points may be based on previously-obtained representations of the objects in the scene. For example, system 200 may iteratively obtain representations (e.g., instances of representation 112), determine latent-space representation 116 based on the instances of representation 112, determine clusters 120 based on the determined clusters 120, and store the determined clusters 120 at history 222. In further iterations, system 200 may update stored clusters 120.

In some aspects, to update the previously-determined clusters of points, the computing device (or one or more components thereof) may associate the points of the latent-space representation of the objects with the previously-determined clusters of points. For example, clusterer 118 may store clusters of points in history 222 and associate points based on latent-space representation 116 with previously-determined clusters of points.

In some aspects, the similarities between the points of the latent-space representation of the objects and the previously-determined clusters of points are determined using on a clustering algorithm. For example, clusterer 118 may cluster points of latent-space representation 116 with points of a previously-determined instance of latent-space representation 116, for example, stored by history 222.

In some aspects, the clustering algorithm may be, or may include, at least one of: Density-Based Spatial Clustering of Applications with Noise (DBSCAN), random sample consensus (RANSAC), or mean shift.

At block 806, the computing device (or one or more components thereof) may determine representative values of the clusters of points. For example, value determiner 124 of FIG. 1 may determine representative values 126 of clusters 120.

In some aspects, to determine representative values of the clusters of points, the computing device (or one or more components thereof) may determine centroid of the clusters of points. For example, value determiner 124 may determine centroids of clusters 120.

At block 808, the computing device (or one or more components thereof) may generate, using a decoder machine-learning model, a reconstructed representation of the objects in the scene based on the representative values of the clusters of points. For example, decoder 128 of FIG. 1 may generate reconstructed representation 130 based on representative values 126.

In some aspects, the encoder machine-learning model and the decoder machine-learning model may be trained together as an autoencoder. For example, encoder 114 and decoder 128 may be trained together as an autoencoder.

In some aspects, the computing device (or one or more components thereof) may transform the representation of objects in the scene into a reference coordinate system prior to generating the latent-space representation of the objects based on the representation of objects. For example, transformer 210 of FIG. 2 may transform representation 206 into a reference coordinate system to generate representation 112.

In some aspects, the computing device (or one or more components thereof) may transform the reconstructed representation of objects in the scene into a device coordinate system. For example, transformer 234 may transform reconstructed representation 130 into a device coordinate system to generate reconstructed representation 236.

In some aspects, the computing device (or one or more components thereof) may be part of a vehicle. The objects may be, or may include, at least one of: boundaries of at least one lane on a road; at least one edge of the at least one lane of the road; dividers of the at least one lane of the road; markings of the at least one lane of the road; on-road traffic markings of the road; or crosswalk markings of the road. For example, the objects represented by representation 112 may be, or may include, objects such as lane boundary 402, lane boundary 404, lane boundary 406, lane boundary 408, lane boundary 410, road boundary 412, centerline 414, and/or centerline 416.

In some aspects, the computing device (or one or more components thereof) may be, or may include, a computing device of a vehicle. In some aspects, the computing device (or one or more components thereof) may adjust an operating parameter of the vehicle based on the reconstructed representation of the objects in the scene. In some aspects, the operating parameter may be associated with at least one of a path for the vehicle to travel, an automatic braking parameter for operating one or more brakes of the vehicle, a lane change parameter for causing the vehicle to navigate from a first lane to a second lane, or displaying information related to the reconstructed representation of the objects in the scene using a user interface of the vehicle.

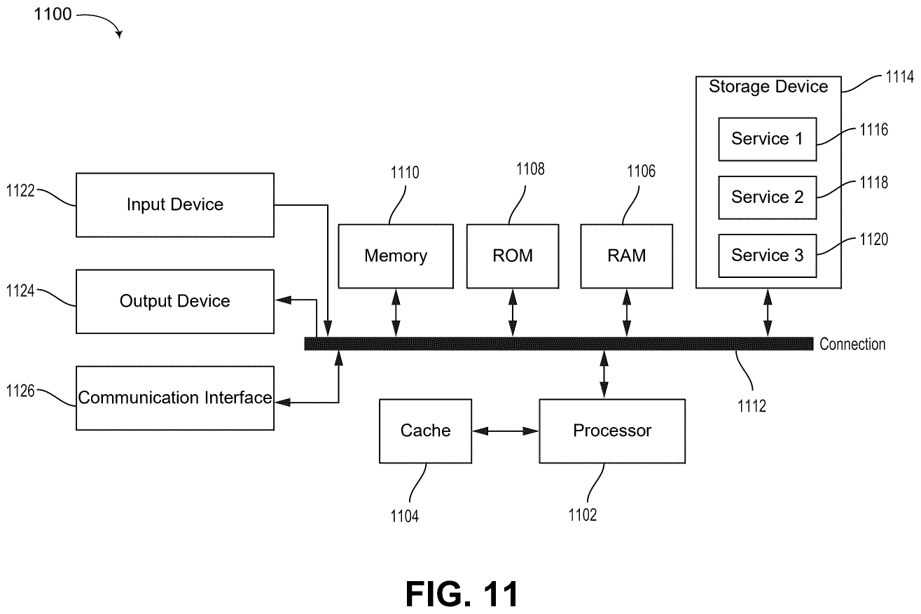

In some examples, as noted previously, the methods described herein (e.g., process 700 of FIG. 7, process 800 of FIG. 8, and/or other methods described herein) can be performed, in whole or in part, by a computing device or apparatus. In one example, one or more of the methods can be performed by system 100 of FIG. 1, system 200 of FIG. 2, or by another system or device. In another example, one or more of the methods (e.g., process 700, process 800, and/or other methods described herein) can be performed, in whole or in part, by the computing-device architecture 1100 shown in FIG. 11. For instance, a computing device with the computing-device architecture 1100 shown in FIG. 11 can include, or be included in, the components of the system 100 and/or system 200 and can implement the operations of process 700, process 800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, process 800, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, process 800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

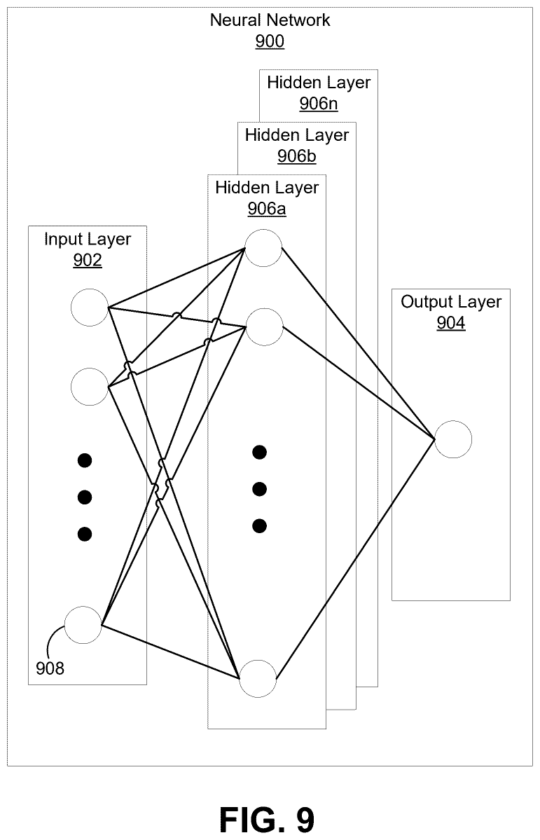

FIG. 9 is an illustrative example of a neural network 900 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 900 may be an example of, or can implement, encoder 114 and/or decoder 128 of FIG. 1 and FIG. 2, autoencoder 500, encoding network 502, and/or decoding network 504 of FIG. 5.

An input layer 902 includes input data. In one illustrative example, input layer 902 can include data representing latent-space representation 116 of FIG. 1 and FIG. 2. Neural network 900 includes multiple hidden layers, for example, hidden layers 906a, 906b, through 906n. The hidden layers 906a, 906b, through hidden layer 906n include “n” number of hidden layers, where “n” is an integer greater than or equal to one. The number of hidden layers can be made to include as many layers as needed for the given application. Neural network 900 further includes an output layer 904 that provides an output resulting from the processing performed by the hidden layers 906a, 906b, through 906n. In one illustrative example, output layer 904 can provide reconstructed representation 130 of FIG. 1 and FIG. 2.

Neural network 900 may be, or may include, a multi-layer neural network of interconnected nodes. Each node can represent a piece of information. Information associated with the nodes is shared among the different layers and each layer retains information as information is processed. In some cases, neural network 900 can include a feed-forward network, in which case there are no feedback connections where outputs of the network are fed back into itself. In some cases, neural network 900 can include a recurrent neural network, which can have loops that allow information to be carried across nodes while reading in input.

Information can be exchanged between nodes through node-to-node interconnections between the various layers. Nodes of input layer 902 can activate a set of nodes in the first hidden layer 906a. For example, as shown, each of the input nodes of input layer 902 is connected to each of the nodes of the first hidden layer 906a. The nodes of first hidden layer 906a can transform the information of each input node by applying activation functions to the input node information. The information derived from the transformation can then be passed to and can activate the nodes of the next hidden layer 906b, which can perform their own designated functions. Example functions include convolutional, up-sampling, data transformation, and/or any other suitable functions. The output of the hidden layer 906b can then activate nodes of the next hidden layer, and so on. The output of the last hidden layer 906n can activate one or more nodes of the output layer 904, at which an output is provided. In some cases, while nodes (e.g., node 908) in neural network 900 are shown as having multiple output lines, a node has a single output and all lines shown as being output from a node represent the same output value.

In some cases, each node or interconnection between nodes can have a weight that is a set of parameters derived from the training of neural network 900. Once neural network 900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 900 to be adaptive to inputs and able to learn as more and more data is processed.

Neural network 900 may be pre-trained to process the features from the data in the input layer 902 using the different hidden layers 906a, 906b, through 906n in order to provide the output through the output layer 904. In an example in which neural network 900 is used to identify features in images, neural network 900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 000 000 0].

In some cases, neural network 900 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 900 is trained well enough so that the weights of the layers are accurately tuned.

For the example of identifying objects in images, the forward pass can include passing a training image through neural network 900. The weights are initially randomized before neural network 900 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 900, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 900 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 900 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and n denotes a learning rate. The learning rate can be set to any suitable value, with a high learning rate including larger weight updates and a lower value indicating smaller weight updates.

Neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 900 can include any other deep network other than a CNN, such as an autoencoder, a deep belief nets (DBNs), a Recurrent Neural Networks (RNNs), among others.

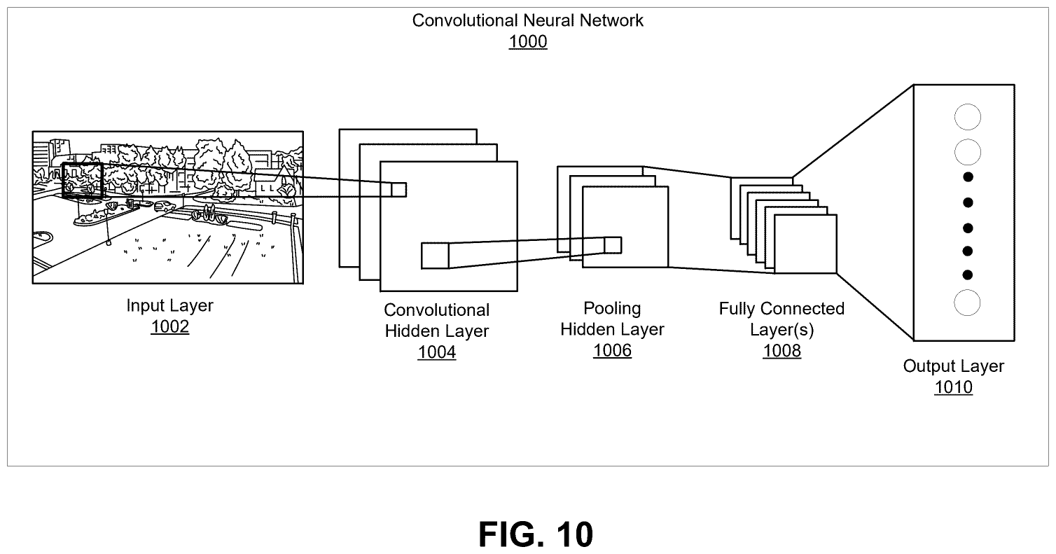

FIG. 10 is an illustrative example of a convolutional neural network (CNN) 1000. The input layer 1002 of the CNN 1000 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1004, an optional non-linear activation layer, a pooling hidden layer 1006, and fully connected layer 1008 (which fully connected layer 1008 can be hidden) to get an output at the output layer 1010. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 can be the convolutional hidden layer 1004. The convolutional hidden layer 1004 can analyze image data of the input layer 1002. Each node of the convolutional hidden layer 1004 is connected to a region of nodes (pixels) of the input image called a receptive field. The convolutional hidden layer 1004 can be considered as one or more filters (each filter corresponding to a different activation or feature map), with each convolutional iteration of a filter being a node or neuron of the convolutional hidden layer 1004. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1004. Each connection between a node and a receptive field for that node learns a weight and, in some cases, an overall bias such that each node learns to analyze its particular local receptive field in the input image. Each node of the convolutional hidden layer 1004 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1004 is due to each node of the convolutional layer being applied to its corresponding receptive field. For example, a filter of the convolutional hidden layer 1004 can begin in the top-left corner of the input image array and can convolve around the input image. As noted above, each convolutional iteration of the filter can be considered a node or neuron of the convolutional hidden layer 1004. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1004. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1004.

The mapping from the input layer to the convolutional hidden layer 1004 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1004 can include several activation maps in order to identify multiple features in an image. The example shown in FIG. 10 includes three activation maps. Using three activation maps, the convolutional hidden layer 1004 can detect three different kinds of features, with each feature being detectable across the entire image.

In some examples, a non-linear hidden layer can be applied after the convolutional hidden layer 1004. The non-linear layer can be used to introduce non-linearity to a system that has been computing linear operations. One illustrative example of a non-linear layer is a rectified linear unit (ReLU) layer. A ReLU layer can apply the function f(×)=max(0, x) to all of the values in the input volume, which changes all the negative activations to 0. The ReLU can thus increase the non-linear properties of the CNN 1000 without affecting the receptive fields of the convolutional hidden layer 1004.

The pooling hidden layer 1006 can be applied after the convolutional hidden layer 1004 (and after the non-linear hidden layer when used). The pooling hidden layer 1006 is used to simplify the information in the output from the convolutional hidden layer 1004. For example, the pooling hidden layer 1006 can take each activation map output from the convolutional hidden layer 1004 and generates a condensed activation map (or feature map) using a pooling function. Max-pooling is one example of a function performed by a pooling hidden layer. Other forms of pooling functions be used by the pooling hidden layer 1006, such as average pooling, L2-norm pooling, or other suitable pooling functions. A pooling function (e.g., a max-pooling filter, an L2-norm filter, or other suitable pooling filter) is applied to each activation map included in the convolutional hidden layer 1004. In the example shown in FIG. 10, three pooling filters are used for the three activation maps in the convolutional hidden layer 1004.

In some examples, max-pooling can be used by applying a max-pooling filter (e.g., having a size of 2×2) with a stride (e.g., equal to a dimension of the filter, such as a stride of 2) to an activation map output from the convolutional hidden layer 1004. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1004 having a dimension of 24×24 nodes, the output from the pooling hidden layer 1006 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1006 to every one of the output nodes in the output layer 1010. Using the example above, the input layer includes 28×28 nodes encoding the pixel intensities of the input image, the convolutional hidden layer 1004 includes 3×24×24 hidden feature nodes based on application of a 5×5 local receptive field (for the filters) to three activation maps, and the pooling hidden layer 1006 includes a layer of 3×12×12 hidden feature nodes based on application of max-pooling filter to 2×2 regions across each of the three feature maps. Extending this example, the output layer 1010 can include ten output nodes. In such an example, every node of the 3×12×12 pooling hidden layer 1006 is connected to every node of the output layer 1010.

The fully connected layer 1008 can obtain the output of the previous pooling hidden layer 1006 (which should represent the activation maps of high-level features) and determines the features that most correlate to a particular class. For example, the fully connected layer 1008 can determine the high-level features that most strongly correlate to a particular class and can include weights (nodes) for the high-level features. A product can be computed between the weights of the fully connected layer 1008 and the pooling hidden layer 1006 to obtain probabilities for the different classes. For example, if the CNN 1000 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1010 can include an M-dimensional vector (in the prior example, M=10). M indicates the number of classes that the CNN 1000 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of system 100 of FIG. 1, system 200 of FIG. 2 and/or other devices, modules, or systems described herein. Additionally or alternatively, computing-device architecture 1100 may be configured to perform process 700, process 800, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

In block 1202, routine 1200 generates, using an encoder machine-learning model, a latent-space representation of objects based on a representation of the objects in a scene. In block 1204, routine 1200 clusters points of the latent-space representation of the objects, to generate clusters of points. In block 1206, routine 1200 determines representative values of the clusters of points. In block 1208, routine 1200 generates, using a decoder machine-learning model, a reconstructed representation of the objects in the scene based on the representative values of the clusters of points.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“_”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

### Illustrative Aspects of the Disclosure Include

Aspect 1. An apparatus for determining object-location information, the apparatus comprising: at least one memory; and at least one processor coupled to the at least one memory and configured to: generate, using an encoder machine-learning model, a latent-space representation of objects based on a representation of the objects in a scene; cluster points of the latent-space representation of the objects, to generate clusters of points; determine representative values of the clusters of points; and generate, using a decoder machine-learning model, a reconstructed representation of the objects in the scene based on the representative values of the clusters of points.
Aspect 2. The apparatus of aspect 1, wherein the at least one processor is configured to: obtain a captured representation of the scene; and generate, using a machine-learning model, the representation of the objects of the scene based on the captured representation of the scene.
Aspect 3. The apparatus of aspect 2, wherein the captured representation of the scene comprises at least one of an image of the scene or a point-cloud representation of the scene.
Aspect 4. The apparatus of aspect 3, wherein the point-cloud representation of the scene is based on at least one of a light detection and ranging (LIDAR) capture of the scene or a radio detection and ranging (RADAR) capture of the scene.
Aspect 5. The apparatus of any one of aspects 1 to 4, wherein the representation of the objects comprises at least one of a polyline representation of the objects or a polygon representation of the objects.
Aspect 6. The apparatus of any one of aspects 1 to 5, wherein to cluster the points of the latent-space representation of the objects, the at least one processor is configured to update previously-determined clusters of points of latent-space representations of the objects, based on the points of the latent-space representation of the objects, to generate the clusters of points.
Aspect 7. The apparatus of aspect 6, wherein the previously-determined clusters of points are based on previously-obtained representations of the objects in the scene.
Aspect 8. The apparatus of aspect 7, wherein, to update the previously-determined clusters of points, the at least one processor is configured to associate the points of the latent-space representation of the objects with the previously-determined clusters of points.
Aspect 9. The apparatus of aspect 8, wherein the points of the latent-space representation of the objects are associated with the previously-determined clusters of points based on similarities between the points of the latent-space representation of the objects and the previously-determined clusters of points.
Aspect 10. The apparatus of aspect 9, wherein the similarities between the points of the latent-space representation of the objects and the previously-determined clusters of points are determined using on a clustering algorithm.
Aspect 11. The apparatus of aspect 10, wherein the clustering algorithm comprises at least one of: Density-Based Spatial Clustering of Applications with Noise (DBSCAN), random sample consensus (RANSAC), or mean shift.
Aspect 12. The apparatus of any one of aspects 1 to 11, wherein to determine representative values of the clusters of points, the at least one processor is configured to determine centroid of the clusters of points.
Aspect 13. The apparatus of any one of aspects 1 to 12, wherein the encoder machine-learning model and the decoder machine-learning model are trained together as an autoencoder.
Aspect 14. The apparatus of any one of aspects 1 to 13, wherein the at least one processor is configured to transform the representation of objects in the scene into a reference coordinate system prior to generating the latent-space representation of the objects based on the representation of objects.
Aspect 15. The apparatus of any one of aspects 1 to 14, wherein the at least one processor is configured to transform the reconstructed representation of objects in the scene into a device coordinate system.
Aspect 16. The apparatus of any one of aspects 1 to 15, wherein the apparatus is part of a vehicle, and wherein the objects comprises at least one of: boundaries of at least one lane on a road; at least one edge of the at least one lane of the road; dividers of the at least one lane of the road; markings of the at least one lane of the road; on-road traffic markings of the road; or crosswalk markings of the road.
Aspect 17. The apparatus of any one of aspects 1 to 16, wherein the apparatus is a computing device of a vehicle.
Aspect 18. The apparatus of aspect 17, wherein the at least one processor is configured to adjust an operating parameter of the vehicle based on the reconstructed representation of the objects in the scene.
Aspect 19. The apparatus of aspect 18, wherein the operating parameter is associated with at least one of a path for the vehicle to travel, an automatic braking parameter for operating one or more brakes of the vehicle, a lane change parameter for causing the vehicle to navigate from a first lane to a second lane, or displaying information related to the reconstructed representation of the objects in the scene using a user interface of the vehicle.
Aspect 20. A method for determining object-location information, the method comprising: generating, using an encoder machine-learning model, a latent-space representation of objects based on a representation of the objects in a scene; clustering points of the latent-space representation of the objects, to generate clusters of points; determining representative values of the clusters of points; and generating, using a decoder machine-learning model, a reconstructed representation of the objects in the scene based on the representative values of the clusters of points.
Aspect 21. The method of aspect 20, further comprising: obtaining a captured representation of the scene; and generating, using a machine-learning model, the representation of the objects of the scene based on the captured representation of the scene.
Aspect 22. The method of aspect 21, wherein the captured representation of the scene comprises at least one of an image of the scene or a point-cloud representation of the scene.
Aspect 23. The method of aspect 22, wherein the point-cloud representation of the scene is based on at least one of a light detection and ranging (LIDAR) capture of the scene or a radio detection and ranging (RADAR) capture of the scene.
Aspect 24. The method of any one of aspects 20 to 23, wherein the representation of the objects comprises at least one of a polyline representation of the objects or a polygon representation of the objects.
Aspect 25. The method of any one of aspects 20 to 24, wherein clustering the points of the latent-space representation of the objects comprises updating previously-determined clusters of points of latent-space representations of the objects, based on the points of the latent-space representation of the objects, to generate the clusters of points.
Aspect 26. The method of aspect 25, wherein the previously-determined clusters of points are based on previously-obtained representations of the objects in the scene.
Aspect 27. The method of aspect 26, wherein, updating the previously-determined clusters of points comprises associating the points of the latent-space representation of the objects with the previously-determined clusters of points.
Aspect 28. The method of aspect 27, wherein the points of the latent-space representation of the objects are associated with the previously-determined clusters of points based on similarities between the points of the latent-space representation of the objects and the previously-determined clusters of points.
Aspect 29. The method of aspect 28, wherein the similarities between the points of the latent-space representation of the objects and the previously-determined clusters of points are determined using on a clustering algorithm.
Aspect 30. The method of aspect 29, wherein the clustering algorithm comprises at least one of: Density-Based Spatial Clustering of Applications with Noise (DBSCAN), random sample consensus (RANSAC), or mean shift.
Aspect 31. The method of any one of aspects 20 to 30, wherein determining representative values of the clusters of points comprises determining centroid of the clusters of points.
Aspect 32. The method of any one of aspects 20 to 31, wherein the encoder machine-learning model and the decoder machine-learning model are trained together as an autoencoder.
Aspect 33. The method of any one of aspects 20 to 32, further comprising transforming the representation of objects in the scene into a reference coordinate system prior to generating the latent-space representation of the objects based on the representation of objects.
Aspect 34. The method of any one of aspects 20 to 33, further comprising transforming the reconstructed representation of objects in the scene into a device coordinate system.
Aspect 35. The method of any one of aspects 20 to 34, wherein the objects comprises at least one of: boundaries of at least one lane on a road; at least one edge of the at least one lane of the road; dividers of the at least one lane of the road; markings of the at least one lane of the road; on-road traffic markings of the road; or crosswalk markings of the road.
Aspect 36. The method of any one of aspects 20 to 35, further comprising adjusting an operating parameter of a vehicle based on the reconstructed representation of the objects in the scene.
Aspect 37. The method of aspect 36, wherein the operating parameter is associated with at least one of a path for the vehicle to travel, an automatic braking parameter for operating one or more brakes of the vehicle, a lane change parameter for causing the vehicle to navigate from a first lane to a second lane, or displaying information related to the reconstructed representation of the objects in the scene using a user interface of the vehicle.
Aspect 38. A non-transitory computer-readable storage medium having stored thereon instructions that, when executed by at least one processor, cause the at least one processor to perform operations according to any of aspects 20 to 37.
Aspect 39. An apparatus for providing virtual content for display, the apparatus comprising one or more means for perform operations according to any of aspects 20 to 37.

What is claimed is:

1. An apparatus for determining object-location information, the apparatus comprising:
at least one memory; and
at least one processor coupled to the at least one memory and configured to:
generate, using an encoder machine-learning model, a latent-space representation of objects based on a representation of the objects in a scene;
cluster points of the latent-space representation of the objects, to generate clusters of points;
determine representative values of the clusters of points; and
generate, using a decoder machine-learning model, a reconstructed representation of the objects in the scene based on the representative values of the clusters of points.

2. The apparatus of claim 1, wherein the at least one processor is configured to:
obtain a captured representation of the scene; and
generate, using a machine-learning model, the representation of the objects of the scene based on the captured representation of the scene.

3. The apparatus of claim 2, wherein the captured representation of the scene comprises at least one of an image of the scene or a point-cloud representation of the scene.

4. The apparatus of claim 3, wherein the point-cloud representation of the scene is based on at least one of a light detection and ranging (LIDAR) capture of the scene or a radio detection and ranging (RADAR) capture of the scene.

5. The apparatus of claim 1, wherein the representation of the objects comprises at least one of a polyline representation of the objects or a polygon representation of the objects.

6. The apparatus of claim 1, wherein to cluster the points of the latent-space representation of the objects, the at least one processor is configured to update previously-determined clusters of points of latent-space representations of the objects, based on the points of the latent-space representation of the objects, to generate the clusters of points.

7. The apparatus of claim 6, wherein the previously-determined clusters of points are based on previously-obtained representations of the objects in the scene.

8. The apparatus of claim 7, wherein, to update the previously-determined clusters of points, the at least one processor is configured to associate the points of the latent-space representation of the objects with the previously-determined clusters of points.

9. The apparatus of claim 8, wherein the points of the latent-space representation of the objects are associated with the previously-determined clusters of points based on similarities between the points of the latent-space representation of the objects and the previously-determined clusters of points.

10. The apparatus of claim 9, wherein the similarities between the points of the latent-space representation of the objects and the previously-determined clusters of points are determined using on a clustering algorithm.

11. The apparatus of claim 10, wherein the clustering algorithm comprises at least one of: Density-Based Spatial Clustering of Applications with Noise (DBSCAN), random sample consensus (RANSAC), or mean shift.

12. The apparatus of claim 1, wherein to determine representative values of the clusters of points, the at least one processor is configured to determine centroid of the clusters of points.

13. The apparatus of claim 1, wherein the encoder machine-learning model and the decoder machine-learning model are trained together as an autoencoder.

14. The apparatus of claim 1, wherein the at least one processor is configured to transform the representation of objects in the scene into a reference coordinate system prior to generating the latent-space representation of the objects based on the representation of objects.

15. The apparatus of claim 1, wherein the at least one processor is configured to transform the reconstructed representation of objects in the scene into a device coordinate system.

16. The apparatus of claim 1, wherein the apparatus is part of a vehicle, and wherein the objects comprises at least one of:
boundaries of at least one lane on a road;
at least one edge of the at least one lane of the road;
dividers of the at least one lane of the road;
markings of the at least one lane of the road;
on-road traffic markings of the road; or
crosswalk markings of the road.

17. The apparatus of claim 1, wherein the apparatus is a computing device of a vehicle.

18. The apparatus of claim 17, wherein the at least one processor is configured to adjust an operating parameter of the vehicle based on the reconstructed representation of the objects in the scene.

19. The apparatus of claim 18, wherein the operating parameter is associated with at least one of a path for the vehicle to travel, an automatic braking parameter for operating one or more brakes of the vehicle, a lane change parameter for causing the vehicle to navigate from a first lane to a second lane, or displaying information related to the reconstructed representation of the objects in the scene using a user interface of the vehicle.

20. A method for determining object-location information, the method comprising:
generating, using an encoder machine-learning model, a latent-space representation of objects based on a representation of the objects in a scene;
clustering points of the latent-space representation of the objects, to generate clusters of points;
determining representative values of the clusters of points; and
generating, using a decoder machine-learning model, a reconstructed representation of the objects in the scene based on the representative values of the clusters of points.
